(19) United States
(12) Patent Application Publication
(10) Pub. No.: US 2007/0194915 A1
(43) Pub. Date: Aug. 23, 2007

(54) SENSING SYSTEM USING OPTICAL FIBER CABLE

(76) Inventor: Hong-Gi Chun, Seoul (KR)

Correspondence Address: IPLA P.A., 3580 WILSHIRE BLVD., 17TH FLOOR, LOS ANGELES, CA, 90010, US

(21) Appl. No.: 11/533,284

(22) Filed: Sep. 19, 2006

(30) Foreign Application Priority Data
Feb. 20, 2006 (KR) 10-2006-0016151

(51) Int. Cl. G06M 7/00; G08B 13/00; H01J 40/14

(52) U.S. Cl. 340/541; 250/221

(57) ABSTRACT

A sensing system using an optical fiber cable comprises a sensor unit for sensing an external intrusion, a local monitoring controller for receiving a sensing of the sensor unit and a central monitoring controller for controlling the local monitoring controller. The sensing system is reliable, and fewer effects are obtained with respect to an external environment such as a weather condition while achieving an easier installation irrespective of an installation area and an easier maintenance.

### CROSS REFERENCE

Applicant claims foreign priority under Paris Convention and 35 U.S.C. §119 to a Korean Patent Application No. 10-2006-0016151, filed Feb. 20, 2006 with the Korean Intellectual Property Office.

### TECHNICAL FIELD

The present invention relates to a sensing system using an optical fiber cable, and in particular to a sensing system using an optical fiber cable in which the sensing system is reliable, and fewer affects are obtained with respect to an external environment such as a weather condition while achieving an easier installation irrespective of an installation area and an easier maintenance.

### BACKGROUND ART

Generally, numerous guards and high costs are needed so as to prevent an intrusion and destruction by an intruder or destruction by aging and impact. When a guardian leaves from his position for a second, a guarding operation may be failed. In case of bad weathers or night in which visibility is not good, a guarding operation may be also failed.

An automatic monitoring system may be necessary, which uses a sensor as an auxiliary monitoring means for a military monitoring operation or an important facility by persons or a monitoring means with respect to less important facilities. In order to implement the above automatic monitoring system, an infrared ray camera or a closed circuit television is developed. However, the numbers of needed cameras and monitors disadvantageously increase in proportion to the number of guarding points. A monitoring staff is always needed. If a guardian leaves his position for a second, a guarding operation may be failed.

In addition, a sensing system using an optical fiber cable is developed. When a power failure occurs or a certain intruder bends or cuts an optical fiber cable, the whole system is stopped until maintenance is finished. When a certain element except for an optical fiber cable is exchanged or maintained, the system should be stopped. During the above operations, a guarding operation is also stopped.

### DISCLOSURE OF THE INVENTION

Accordingly, it is an object of the present invention to provide a sensing system using an optical fiber cable which overcomes the problems encountered in the conventional art.

It is another object of the present invention to provide a sensing system using an optical fiber in which the sensing system is reliable, and fewer effects are obtained with respect to an external environment such as a weather condition while achieving an easier installation irrespective of an installation area and an easier maintenance.

To achieve the above objects, in a sensing system which includes a sensor unit for monitoring an external intrusion, a local monitoring controller for receiving a detection of the sensor unit, and a central monitoring controller for controlling the local monitoring controller, there is provided a sensing system using an optical fiber cable characterized in that the sensor unit comprises a sensor fence formed in such a manner that one optical fiber is formed in a net shape using a plurality of connection members, and a detection sensor for detecting an external intrusion, and the local monitoring controller comprises a central process unit for processing all data of an inner side and managing a system, a peripheral control unit which is connected with the central process unit for detecting the sensing of the detection sensor of the sensor unit and controlling a camera unit, an alarming unit and a temperature detection unit, an OTDR(Optical Time Domain Reflectometer) unit which is connected with the sensor fence of the sensor unit for detecting a bending and cutting of the optical fiber cable and generating an optical measurement data and alarming data, a communication unit which is connected with the central process unit for transmitting an optical measurement data and alarming data detected or generated by the peripheral control unit and OTDR unit to the central process unit, and a power supply unit which converts an AC into a DC and supplies the DC to each unit.

The local monitoring controller further comprises a camera unit for photographing a corresponding area in accordance with its control, an alarming unit for generating an alarm, and a temperature detection unit for detecting a surrounding temperature.

The camera unit may be formed of a digital camera, an analog camera, a CCTV or a combination of the same. The alarming unit may be formed of an alarming light, a siren, an alarm, etc.

In the arrangement of the sensor fence and the OTDR unit, the OTDR unit is connected with an optical connector, and one end of the optical fiber cable of the sensor fence is connected with the optical connector. A finishing connector connected with the OTDR unit is connected with the other end of the optical fiber cable, the finishing connector being connected instead of the optical connector in an emergency situation.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating the whole construction of a sensing system using an optical fiber cable according to the present invention;

FIG. 2 is a block diagram illustrating a sensing system using an optical fiber cable according to the present invention;

FIG. 3 is a block diagram illustrating an OTDR (Optical Time Domain Reflectometer) unit of FIG. 2;

FIG. 4 is an enlarged view of a sensor fence according to the present invention;

FIG. 5 is a graph of a waveform variation as an optical fiber cable is bent according to the present invention; and

FIG. 6 is a graph of a waveform variation as an optical fiber cable is cut according to the present invention.

### MODES FOR CARRYING OUT THE INVENTION

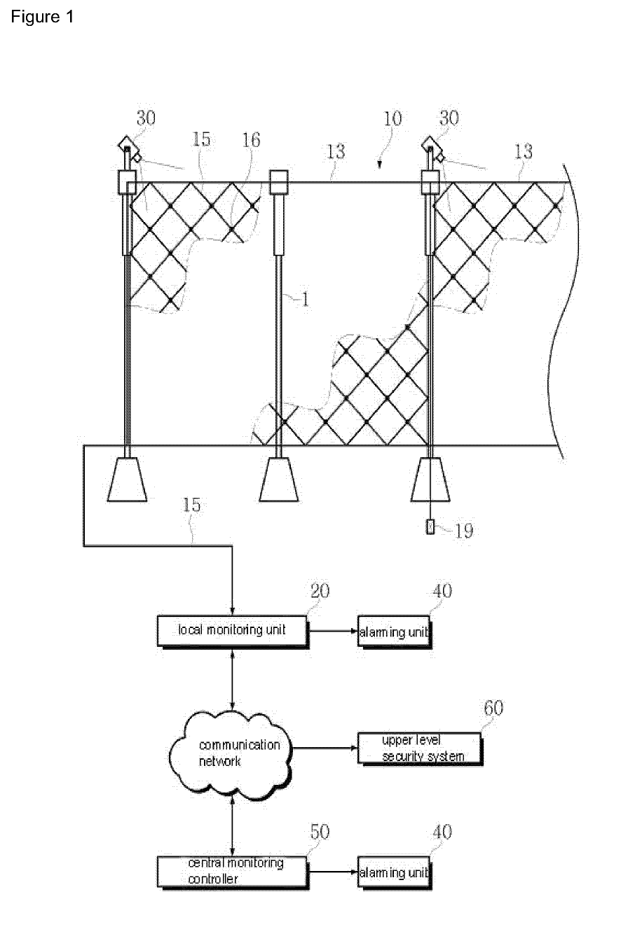

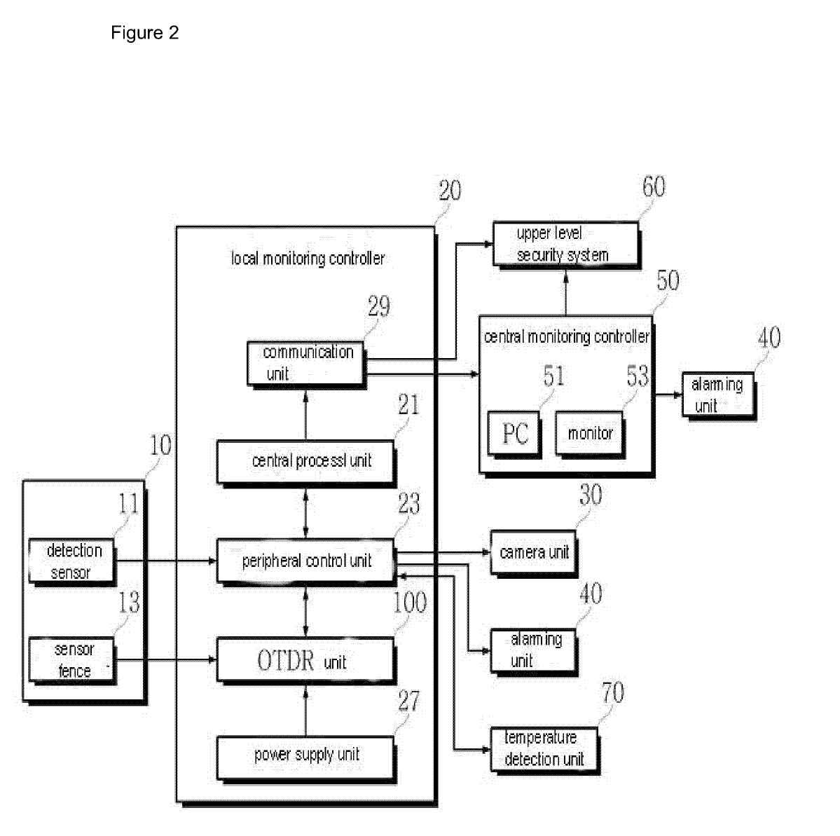

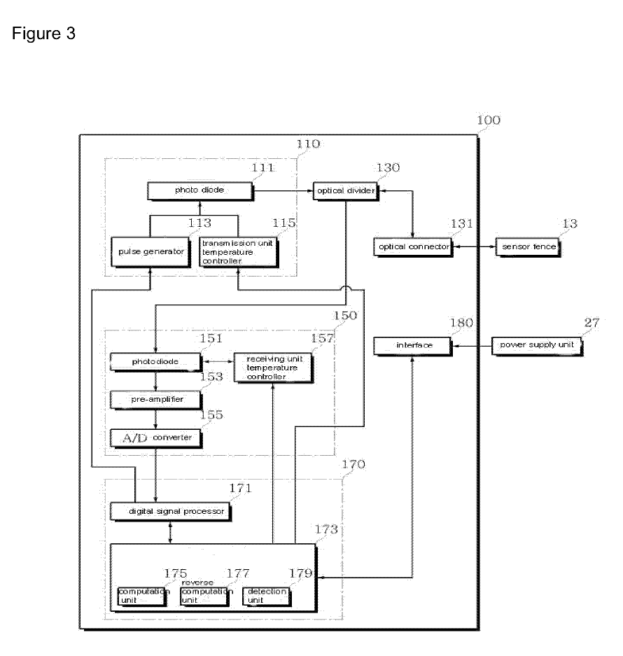

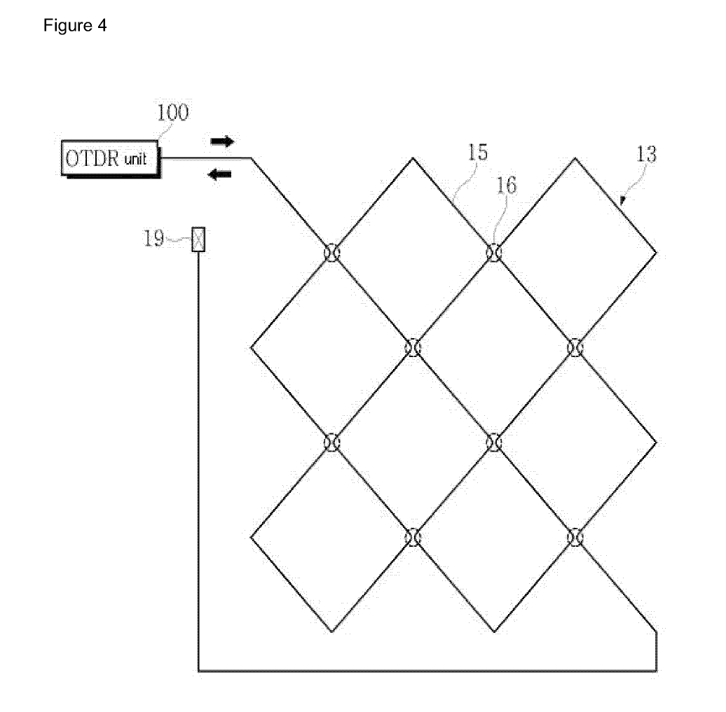

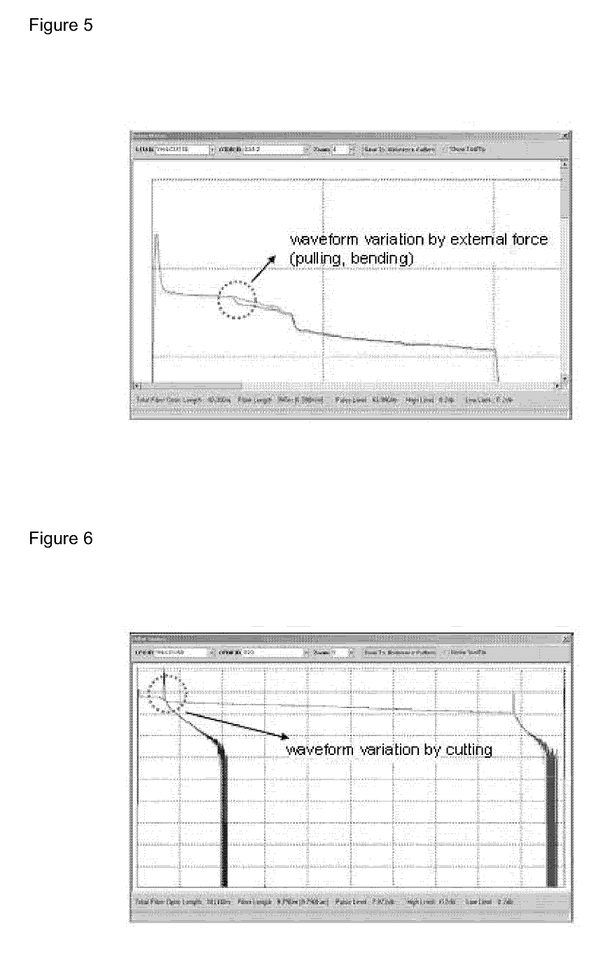

The preferred embodiments of the present invention will be described with reference to the accompanying drawings. FIG. 1 is a schematic view illustrating the whole construction of a sensing system using an optical fiber cable according to the present invention. FIG. 2 is a block diagram illustrating a sensing system using an optical fiber cable according to the present invention. FIG. 3 is a block diagram illustrating an OTDR (Optical Time Domain Reflectometer) unit of FIG. 2. FIG. 4 is an enlarged view of a sensor fence according to the present invention. FIG. 5 is a graph of a waveform variation as an optical fiber cable is bent according to the present invention. FIG. 6 is a graph of a waveform variation as an optical fiber cable is cut according to the present invention.

As shown in FIG. 1, a sensing system using an optical fiber cable according to the present invention comprises a sensor unit 10 for sensing an external intrusion, a local monitoring controller 20 which receives a sensing signal of the sensor unit 10 and is connected with the sensor unit 10, and a central monitoring controller 50 which is connected with the local monitoring controller for controlling the local monitoring controller 20.

The local monitoring controller 20 comprises a camera unit 30 for photographing a corresponding area in accordance with its control, an alarming unit 40 for generating an alarm, and a temperature sensing unit 70 for sensing a surrounding temperature.

The local monitoring controller 20 transmits an optical measurement data and an alarm data to the central monitoring controller 50. The central monitoring controller 50 analyzes the data from the local monitoring controller 20 for thereby recognizing an intrusion position. The alarming unit 40 is installed at the local monitoring unit 20 or the central monitoring unit 50 for thereby generating an alarm in accordance with a control of the local monitoring controller 20 or the central monitoring controller 50.

The temperature sensing unit 70 measures a surrounding temperature of the local monitoring unit 20 and transmits to the central monitoring controller 50 through the local monitoring controller 20. When it is judged that the temperature from the central monitoring controller 50 damages the local monitoring controller 20, a certain measurement is performed.

The central monitoring controller 50 is connected with the local monitoring controller 20 through a communication network and is provided with a personal computer 51 and a monitor 53. The personal computer 51 is provided with a certain software for analyzing an abnormal optical signal of a sensor fence 13 and is capable of sensing an external intrusion and generating a certain alarm. The central monitoring controller 50 may be designed to operate in relation with an upper level security system 60. Here, the upper level security system 60 represents a security guarding service provider or a police station.

The sensor unit 10 comprises a sensor fence 13 formed of one optical fiber cable 15 capable of sensing a bending and cutting by transmitting a light(light wave pulse), and a detection sensor 11 for sensing an external intrusion.

The sensor fence 13 is installed in a structure of a net shape block in which a plurality of posts 1 are installed at a desired guarding area, and one optical fiber cable 15 and a plurality of connection members 16 are provided at one post 1. If necessary, the sensor fences 13 of multiple blocks may be provided by installing a plurality of posts 1. The height of the sensor fence 13 of a unit block is about 2.5 m, and the width of the same is about 400 m. The camera unit 30 is installed at every unit block of the sensor fence 13. One end of the optical fiber cable 15 of the sensor fence 13 is connected with the local monitoring controller 20, and the other end of the same may leave free or may be finished with a finishing connector 19.

The detection sensor 11 is preferably installed at a position in which the sensor fence 13 cannot be installed. The detection sensor 11 may be formed of one among an infrared ray sensor, an optical sensor and a pressure sensor or a combination of the same.

The sensor fence 13, the detection sensor 11 and the camera unit 30 are controlled by the local monitoring controller 20, and the local monitoring controller 20 is connected with the central monitoring controller 50 or the upper level security system 60 through a communication network.

As shown in FIG. 2, the local monitoring controller 20 comprises a central process unit 21 for processing all data of the inner side and managing the system, and the central process unit 21 is connected with a peripheral control unit 23 for detecting the sensing operation of the detection sensor 11 of the sensor unit 10 and controlling the camera unit 30, the alarming unit 40 and the temperature sensing unit 70, and the peripheral control unit 23 is connected with an OTDR unit 100 which is connected with the sensor fence 13 of the sensor unit 10 for detecting the bending and cutting of the optical fiber cable and generating an optical measurement data and an alarming data.

The central process unit 21 is connected with a communication unit 29 for transmitting an optical measurement data and alarming data detected or generated by the peripheral control unit 23 and the OTDR unit 100 to the central monitoring controller 50 through a communication network. The OTDR unit 100 is connected with a power supply unit 27 for converting an AC to a DC and supplying the converted DC to each unit. Here, the peripheral control unit 23 and the OTDR unit 100 are provided in needed numbers.

The central process unit 21 controls the communication unit 29, the peripheral control unit 23, the OTDR unit 100 and the power supply unit 27, respectively. The power supply unit 27 is formed of a double power device, which is automatically switched off when a certain abnormal situation occurs at the power. The local monitoring controller 20 adapts a hot swap method, so that it is possible to exchange a peripheral control unit having an error or an OTDR having an error in a state that the power is being supplied.

As shown in FIG. 3, the OTDR unit 100 comprises an optical transmission unit 110 in which an optical diode 111 for generating light, a pulse generator 113 for driving the optical diode 111 and a transmission unit temperature controller 115 for controlling the temperature of the optical diode 111 are connected with each other.

In an optical receiving unit 150, a photodiode 151 for converting an optical signal into an electrical signal, a pre-amplifier 153 for amplifying an electrical signal inputted from the photodiode 151, an A/D converter 155 for converting the analog signal amplified by the pre-amplifier 153 into a digital signal, and a receiving unit temperature controller 157 for controlling the temperature of the photodiode 151.

The optical transmission unit 110 and the optical receiving unit 150 are connected with an optical divider 130, respectively, which divides light. Here, the optical divider 130 divides the light generated by the optical transmission unit 110 and the light received by the optical receiving unit 150. There is provided an optical connector 131 for connecting the optical divider 130 and the sensor fence 13 of the sensor unit 10, so that the light of the optical transmission unit 110 is transmitted to the sensor fence 13 of the sensor unit 10, and the light fed back by the sensor fence 13 is transmitted to the optical receiving unit 150.

A processor unit 170 comprises a digital signal processor 171 which is connected with the optical transmission unit 110 and the optical receiving unit 150 for processing the digital signal at high speed converted by the A/D converter 155 of the optical receiving unit 150 and generating a certain data, a computation unit 175 and a reverse computation unit 177 for computing and reverse-computing the data transmitted from the digital signal processor 171, a detection unit 179 for detecting whether the data transmitted from the digital signal processor 171 is transmitted through a certain connector, and a main processor 173 for controlling the transmission unit temperature controller 115 and the receiving unit temperature controller 157.

There is provided an interface 180 which is connected with the processor unit 170 for receiving power from the power supply unit 27.

The operation of the OTDR unit 100 will be described as follows.

When the pulse generator 113 of the OTDR unit 100 allows the optical diode 111 to generate light, the optical divider 130 transmits the light to the optical fiber cable 15 through the optical connector 131. Here, the transmission unit temperature controller 115 controls the temperature of the optical diode 111. When a certain distorted light is inputted into the photodiode 151 of the optical receiving unit 150 in a form of an electrical signal as a certain error occurs at the sensor fence 13, the pre-amplifier 153 amplifies an electrical signal received, and the amplified electrical signal is converted from an analog signal into a digital signal by the A/D converter 155. Here, the receiving unit temperature controller 157 controls the temperature of the photodiode 151.

The digital signal processor 171 of the processor unit 170 processes the converted digital signal at a high speed and generates data, and the data transmitted from the digital signal processor 171 are computed or reverse-computed by the computation unit 175 or the reverse computation unit 177 of the main processor 173, and the distance is computed for thereby judging an area which is intruded. Here, the main processor 173 controls the digital signal processor 171 and the transmission/receiving unit temperature controllers 115 and 157, respectively.

The OTDR unit 100 according to the present invention measures the waveform changed by the bending of the optical fiber cable 15 and the optical loss due to the cutting for thereby judging an area which is intruded. Namely, the OTDR unit 100 uses a back scattering method, and the optical signal, which guides the optical fiber, is scattered and reflected and is moved backwards by a Reyleigh scattering, a mirror surface effect at an outlet of the break point, etc. The backward-moved optical signal property is compared with the input optical signal for thereby measuring the optical loss.

FIG. 4 is a view illustrating a sensor fence 130 connected with the OTDR unit 100. As shown therein, one optical fiber cable 15 is connected in a net shape using a plurality of connection members 16. One end of the optical fiber cable 15 is connected with the OTDR unit 100, and the other end of the same maintains free. The other end of the optical fiber cable 15 may be extended and positioned at a portion near the OTDR unit 100 and may be preferably finished using an additional finishing connector 19.

The finishing connector 19 corresponds to a surplus connector which may be used instead of the optical connector 131 used for connecting the OTDR unit 100 and the optical fiber cable 15. Namely, when the optical fiber cable 15 provided near the optical connector 131 is damaged, the finishing connector 19 connected with the other end of the optical fiber cable 15 is connected with the OTDR unit 100 and is used.

When the optical fiber cable 15 is cut, the distance is computed using the optical signal fed back from the computation unit 175 of the main processor 173 for thereby judging the area which is intruded, so that the finishing connector 19 is connected with the OTDR unit 100. In this state, when the optical fiber cable 15 is cut again, the distance is reverse-computed by the reverse computation unit 177 of the main processor 173 for thereby judging a second intrusion area. At this time, the detection unit 179 of the main processor 173 detects whether it corresponds to the optical connector 131 or the finishing connector 19. The portion for connecting the optical connector 131 and the portion for connecting the finishing connector 19 are differed from each other.

As described above, when the optical fiber cable 15 is damaged at the portion near the optical connector 131, since the finishing connector 19 connected with the other end of the optical fiber cable 15 may be connected with the OTDR unit 100 and may be used, it is possible to maintain the cut portion while monitoring the remaining portions of the optical fiber cable 15.

FIG. 5 is a graph, which shows a waveform variation due to the bending of the optical fiber cable. Namely, it shows a waveform variation due to a bending by an external force such as pulling force. As shown therein, the waveform graph is drawn from the left side to the right side of the drawing and has a certain change in the waveform as indicated by the dotted lines. The above change corresponds to the state in which the bending occurs at a certain portion of the optical fiber cable 15, so that a monitoring person can check the above state. When the optical fiber cable 15 is bent below a set curvature radius, the optical signal is distorted, so that it is possible to detect the bent portion of the optical fiber cable 15.

FIG. 6 is a graph of a waveform variation due to the cutting of the optical fiber cable. It shows a change in the waveform due to the cutting. The waveform graph, which is drawn from the left side to the right side and then is drawn toward the lower side at the end of the right side, corresponds to the normal state of the optical fiber cable 15. In addition, the waveform graph, which is drawn toward the lower side immediately after it is drawn from the left side, corresponds to a state that the optical fiber cable 15 is cut, so that the monitoring person can easily recognize the cut state.

When a certain person intrudes through the sensor fence 13 and pressurizes or cuts the optical fiber cable 15 of the sensor fence 13, the OTDR unit 100 recognizes the above state, and the peripheral control unit 23 connected with the OTDR unit 100 allows the camera unit 30 and the alarming unit 40 to operate. The OTDR unit 100 transmits the position data detected by the sensor fence 13 to the central monitoring controller 50 through the communication unit 29.

The security staff can easily recognize the position, in which the optical fiber cable 15 is bent or cut, using the graphs of FIGS. 5 and 6 shown on the monitor 53 of the central monitoring controller 50. Here, the security staff can perform a proper measurement with respect to the intrusion for himself or in relation with the upper level security system 60.

The present invention may be installed at various areas such as an inclination area, a curved area, a rock area, a sand area, a grounded area, a mountain area, etc. It is possible to monitor very wide areas by continuously arranging a plurality of sensor fences 13 which are formed by the unit of block and by connecting each sensor fence 13 with a corresponding OTDR unit 100. Since the optical fiber cable 15 has a core made of a glass fiber material, when the optical fiber cable 15 is cut, both ends of the cut optical fiber cable 15 are melted and bonded, so that it is very easy to maintain the optical fiber cable 15.

As described above, the present invention relates to a sensing system using an optical fiber cable by which it is easy to detect an intrusion, and the sensing system is reliable, and fewer effects are obtained with respect to an external environment such as a weather condition.

The present invention may be installed at various areas such a grounded area or a mountain area. Maintenance is easy.

Even when an optical fiber cable is damaged at a portion near an optical connector, the finishing connector connected with the other end may be connected and used, so that it is possible to easily repair the cut portion while monitoring the remaining portions.

Since the local monitoring controller according to the present invention adapts a hot swap method, it is possible to maintain a part of the error OTDR in a state that the power is being supplied. The power supply unit is made of a double power device which is automatically switched off when an error occurs at the power, so that it is possible to stably supply power without stopping the power supply.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a sensing system which includes a sensor unit for monitoring an external intrusion, a local monitoring controller for receiving a detection of the sensor unit, and a central monitoring controller for controlling the local monitoring controller, a sensing system using an optical fiber cable characterized in that said sensor unit comprises a sensor fence formed in such a manner that one optical fiber is formed in a net shape using a plurality of connection members, and a detection sensor for detecting an external intrusion, and said local monitoring controller comprises a central process unit for processing all data of an inner side and managing a system, a peripheral control unit which is connected with the central process unit for detecting the sensing of the detection sensor of the sensor unit and controlling a camera unit, an alarming unit and a temperature detection unit, an OTDR (Optical Time Domain Reflectometer) unit which is connected with the sensor fence of the sensor unit for detecting a bending and cutting of the optical fiber cable and generating an optical measurement data and alarming data, a communication unit which is connected with the central process unit for transmitting an optical measurement data and alarming data detected or generated by the peripheral control unit and OTDR unit to the central process unit, and a power supply unit which converts an AC into a DC and supplies the DC to each unit.

2. The system of claim 1, wherein said local monitoring controller further comprises a camera unit for photographing a corresponding area in accordance with its control, an alarming unit for generating an alarm, and a temperature detection unit for detecting a surrounding temperature.

3. The system of claim 1, wherein said OTDR unit is connected with an optical connector, and the optical connector is connected with one end of the optical fiber cable of the sensor fence, and the other end of the optical fiber cable is connected with a finishing connector which is connected with the OTDR unit on behalf of the optical connector in an emergency situation.
